(19) United States
(12) Patent Application Publication
(10) Pub. No.: US 2001/0036336 A1
(43) Pub. Date: Nov. 1, 2001

(54) Method and apparatus for adjusting flux emitted from branched light guides

(75) Inventor: Cheryl Annette Vrieze, St. Paul, MN (US)

Correspondence Address: Office of Intellectual Property Counsel, 3M Innovative Properties Company, PO Box 33427, St. Paul, MN, 55133-3427, US

(73) Assignee: Minnesota Mining and Manufacturing Company

(21) Appl. No.: 09/874,840

(22) Filed: Jun. 5, 2001

Related U.S. Application Data
(63) Continuation of application No. 09/205,849, filed on Dec. 4, 1998.

(51) Int. Cl. G02B 6/26

(52) U.S. Cl. 385/45

(57) ABSTRACT

An optical splitter, having a stem and multiple branches integrally connected to the stem, has a junction between the stem and the multiple branches which is flexible. By controlling the angle between the stem and the multiple branches while maintaining a fixed angle between the multiple branches, i.e., by flexing the junction, the flux emitted from each of the multiple branches is adjustable based on the angle each branch makes with respect to the stem.

### CROSS-REFERENCE TO RELATED APPLICATION

This application is a continuation of pending U.S. patent application Ser. No. 09/205,849, filed Dec. 4, 1998, and incorporated herein by reference.

### BACKGROUND OF THE INVENTION

The present invention relates generally to methods and apparatuses for transporting light from a single source to multiple locations, and more particularly to a method and apparatus for transporting light from a single source to multiple locations, in which the flux emitted from each of several downstream branches is controllable.

Optically transmissive materials may be used as a light guide to propagate light. A light guide typically includes at least one surface adapted to receive light from a light source and an optically smooth surface for reflecting light propagating via total internal reflection along or within the light guide. Common examples of light guides include optical fibers, traditionally used in the data communication industry, and more recently light fibers, used for illumination purposes. For example, U.S. Pat. No. 4,422,719 (the '719 patent) discloses one such illumination device employing light fibers. In such a device, at least one end surface of the light fiber is adapted to receive light from a light source, which light propagates axially along or within the fiber.

One technique for fabricating such an illumination device begins by forming a transparent elongated fiber core. The fiber core is designed such that light that is injected into the fiber at one end travels to the other end without loss of light due to transmission at the surface of the fiber. This well-known phenomenon is called total internal reflection.

Light fibers can also be used as components of an illumination system or a “light transport system.” In these systems, light is normally injected from a single source into at least one end of a light fiber and allowed to exit the fiber at a predetermined position or positions along the length of the fiber. In addition, a “coupler” or “splitter” device may accept light from a single source or a source fiber and distribute the light entering one end of the splitter among a number of output fibers.

Techniques for providing such a division of light flux in the field of communications optical fibers include specific manufacturing of adjustable splitter devices, manufactured to precise specifications, such that the light flux may be divided as needed. These splitters maintain a fixed geometry, relying on variations in refractive index (induced, for example, by electrical fields or changes in temperature) or contact from a separate waveguide to control the division of optical power. Moreover, these splitters and their control means are not applicable to large diameter light fibers because of their size, cost, and the requirement for electrical power supply.

For applications in which the above techniques may not be appropriate to divide optical power between two or more branches, limited geometrical solutions have been developed. In the illumination industry, both multi-port light sources and multi-fiber harnesses are available. However, they offer neither dynamic adjustment capabilities nor consistent color between the receiving (downstream) fibers.

The present invention is therefore directed to the problem of developing an efficient method for allowing for the dynamic adjustment of the amount of flux emitted from each of several downstream light guide branches, while also ensuring that the light is the same color in each guide. In addition, the present invention is directed to the problem of developing a splitter system, including an optical splitter, which is capable of emitting varying amounts of light flux in each branch.

### SUMMARY OF THE INVENTION

The present invention solves these problems by eliminating the need for custom manufactured splitters or multiple sources to provide varying amounts of flux emitted from each of several branched lightguides. To provide dynamic flux adjustment with color integrity, the present invention uses a flexible optical splitter and adjusts the angle of the downstream branches, with respect to the upstream stem. Changing the angle of each downstream branch with respect to the upstream stem adjusts the flux emitted from each downstream branch, thereby eliminating the need for a custom manufactured splitter. Preferably, the optical splitter of the present invention is symmetrical and the angle between the two downstream branches is fixed.

The present invention provides methods and apparatuses for dynamically and adjustably controlling the flux in an illumination device.

According to one aspect of the present invention, a method provides for controlling the amount of light emitted from each of several branches of an optical splitter, wherein each of the branches has a cross-sectional area. The optical splitter has a stem and at least two branches integrally connected to the stem, and a flexible region where the stem and at least two branches join. The angle between the stem of the optical splitter with the branches is adjusted such that the amount of light emitted from each of the two branches is determined based on the adjusted angle.

In another aspect of the present invention, the method includes the step of maintaining a fixed angle between each of the two branches.

In one particular embodiment of the present invention, the stem and the two branches of the optical splitter include light guides. In another embodiment, the light guides include light fibers.

In yet another aspect of the present invention, the color of the light emitted from each of the branches of the optical splitter is substantially the same as the color of light input at the stem of the optical splitter.

In an optical splitter in accordance with an embodiment of the present invention, the stem and the branches preferably are an integrally formed single light guide device.

In a preferred embodiment of the present invention, the optical splitter may comprise one stem and two branches, and may be symmetrical about the central axis of the stem. The angle between the two branches of the optical splitter (angle A of FIG. 2(c)) is fixed and remains constant. Although any angle A may be used in accordance with the present invention, preferably, the angle is between 1° and 90°, more preferably between 1° and 20°, and most preferably, between 1° and 10°.

In an alternative preferred embodiment of the present invention, the optical splitter may comprise one stem and at least two branches and may be asymmetrical with respect to the central axis of the stem. The angle A between the branches remains fixed, having the values described for a symmetrical splitter. In addition, the angle between the stem and a major branch (angle B of FIG. 2(a)) can be between 90° and 180°, preferably between 150° and 180°, and most preferably between 170° and 180°. By the term “major branch” is meant that branch forming the larger or largest angle between the stem and itself.

### BRIEF DESCRIPTION OF THE DRAWINGS

FIG. 1 depicts a perspective view of a Y splitter, which has an upstream stem and two downstream branches, in which the geometry of the splitter may be dynamically adjusted to divide the light entering the upstream stem between the two downstream branches as desired in accordance with the principles of the present invention;

FIGS. 2(a) through 2(c) represent, respectively, a splitter illustratively shown as flexed so as to divide the light emitted 80% from one branch and 20% from the other, 60% from one branch and 40% from the other, and 50% from one branch and 50% from the other, in accordance with the principles of the present invention. In each of FIGS. 2(a) through 2(c), angle A is fixed while angle B can be varied; and

FIG. 3 depicts an alternative embodiment of an optical splitter in accordance with the principles of the present invention, in which the downstream branches may be located in any reference plane and in which the geometry of the splitter may be dynamically adjusted so as to divide light entering the upstream stem between the plurality of downstream branches in accordance with the principles of the present invention.

### DETAILED DESCRIPTION

In accordance with the present invention, the angle made between two or more downstream branches of an optical splitter with respect to an upstream stem is adjusted in such a way so as to control the flux emitted from each of the downstream branches. The present invention also includes a system for adjusting the flux emitted including a splitter, having a flexible junction, mounted to a splitter box, which controls the alignment of the splitter so as to obtain the desired flux division among the downstream branches.

As noted above, in accordance with the present invention, the angle made between a downstream branch with an upstream stem of an optical fiber splitter is adjusted in such a way so as to adjust the proportion of flux from the upstream stem that is emitted into the downstream branch. The method of controlling flux emitted from downstream branches of the present invention is particularly useful in situations where light from a single source must be split, in varying amounts, between multiple terminal illumination devices or, between multiple terminal locations. An example of such a situation is in the illumination of “channel letters,” where the surface area of each letter to be illuminated determines the flux required from the light source for that particular letter. Another example of the practical use of the method/system according to the present invention is that of “overhead lighting” or “task lighting” illumination situations that require illumination with differing flux amounts at several points from a single light source.

The stem and branches of an optical splitter in accordance with the present invention may be any light guide, including a light fiber. Generally, a conventional optical fiber for an “illumination device” has a core fiber with a particular cross-sectional geometry (i.e., circular, elliptical, etc.) and a cladding around the core. The refractive index of the core is greater than the refractive index of the cladding so that the light traveling along or within the light guide is reflected at the surfaces of the light guide with minimal losses in accordance with the principles of total internal reflection. The cladding may be further surrounded by a protective layer of material, or, in its simplest form, may even be ambient air. In a preferred embodiment, a low-index cladding, for example, a dip-coated fluoropolymer, can be used.

In use, a beam of electromagnetic energy, such as visible light, introduced into the core at one end of the fiber is directed to strike the core/cladding interface at an angle greater than the critical angle and so will be totally internally reflected. As a result, the light will be transmitted to the other end of the fiber without significant losses.

A prefabricated optical light fiber splitter (e.g., a “Y-shaped splitter”) may be formed from any well-known means, including but not limited to, the means set out in detail below. A molded optical light fiber splitter constructed in accordance with the requirements of the present invention may be formed, for example, in a molding process using, for example, a conventional two piece mold adapted for injection molding or other common molding procedures.

Regardless of the type of mold that is employed, the curable material that forms the finished article may be any material that cures into a substantially optically transparent material, which can be introduced into the mold and cured at temperatures and/or pressure conditions that do not adversely affect the mold. The curable material may be curable by heat, radiation, or other known processes. Suitable curable materials include a polymerizable compound or mixture. Acrylates are a class of curable materials that are preferable for their transparency properties. Urethanes are also a desirable class of curable materials because a more flexible finished article is obtained, and also, the contraction during curing tends to be minimal, although only certain formulations have desirable transparency properties. Silicones constitute a third desirable class of curable materials because of their transparency, flexibility, and heat resistance.

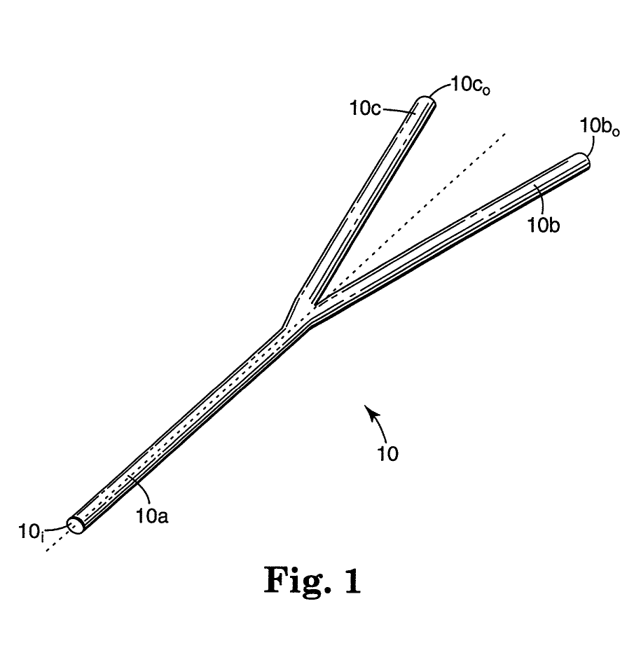

FIG. 1 depicts a perspective view of a symmetrical optical splitter having an upstream stem and two downstream branches. A splitter device, such as a Y splitter, enables the flux emitted from a single light source to be divided among two or more paths to provide light to multiple devices and/or locations.

An optical splitter designed in accordance with the features of the present invention comprises splitter 10, including stem 10a and branches 10b and 10c, as shown in FIG. 1. Light from a light source is injected into input end 10ᵢ of stem 10a, and is transported along the stem in accordance with the principles of total internal reflection, through branches 10b and 10c, to the respective output ends, 10bₒ and 10cₒ, where the light is emitted.

In a conventional uniform (i.e., having branches with the same size and shape) and symmetrical (i.e., “unflexed,” or having branches which are arranged to have a same angle with respect to the base) “Y” shaped splitter device, the light is evenly divided from the input stem among the downstream branches. The splitter illustrated in FIG. 1 allows the method described herein of “flexing” the splitter at the junction where the downstream branches meet the upstream stem to variably control the flux distributed to the branches. The separation angle between the two downstream branches preferably remains fixed.

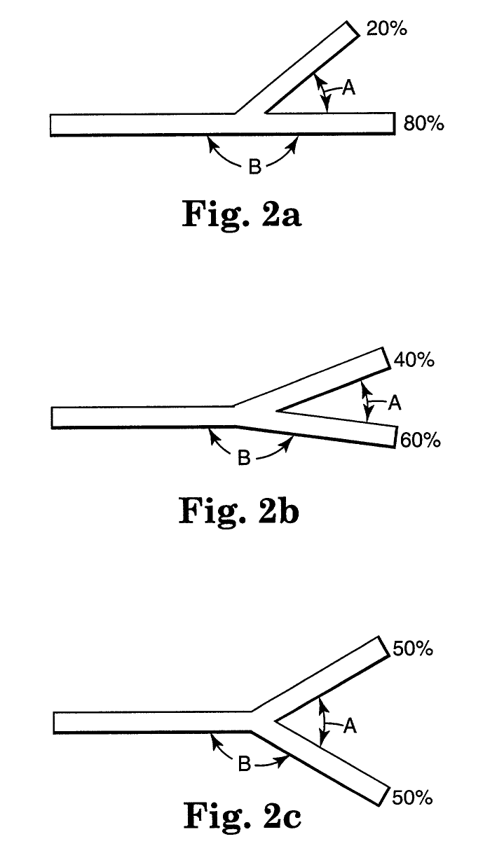

FIGS. 2a-c illustrate a splitter shown “flexed” to divide the light emitted in various proportions, in accordance with the principles of the present invention. In each of FIGS. 2(a) through 2(c), angle A, the angle between the two branches, remains fixed, while angle B, the angle between one of the branches and the stem, as illustrated, can be varied.

FIG. 2a illustrates a “flexed” splitter dividing the light emitted 80% from one branch and 20% from the other, whereas FIG. 2b illustrates a “flexed” splitter dividing the light emitted 60% from one branch and 40% from the other. Finally, FIG. 2c illustrates a splitter shown “flexed” to divide the light emitted 50% from one branch and 50% from the other. In these figures, the alignment of the stem with the branches of the Y splitter is varied, while a fixed angle is maintained between the two branches. Although the splitter illustrated in FIG. 2 has downstream branches that are uniform and equal in cross-sectional area, it will be appreciated by those skilled in the art that the downstream branches could also be unequal and/or non-uniform in cross-sectional area.

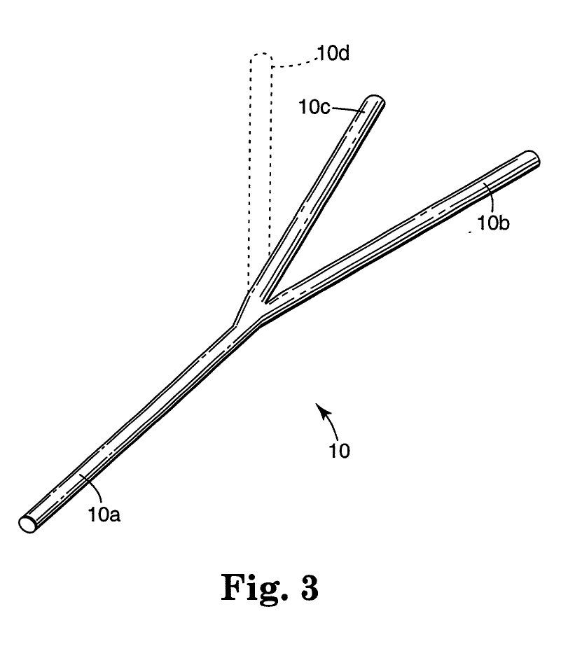

FIG. 3 is an alternative embodiment of a splitter in accordance with the principles of the present invention. Specifically, FIG. 3 shows multiple downstream branches of an optical splitter, in which at least one of the downstream branches (see branch 10d) may lie in a different reference plane from a plane defined by at least two other branches. Again, the angle of the upstream stem with the downstream branches may be dynamically adjusted so as to divide the light emitted from the downstream branches in accordance with the principles of the present invention.

Table 1 shows experimental data obtained in accordance with the present invention. In Table 1, flux (or optical power) measurements (in percentages) are shown for angles, between a first branch of a Y shaped splitter and the stem, of 180 degrees, 177 degrees, 176 degrees and 173 degrees (e.g., angle B in FIG. 2). In addition, the color from the first branch and the color from the second branch were measured for the angles as stated. A Minolta CS-100 tristimulus colorimeter (Minolta Corp., Ramsey, N.J.) was used to measure the color of the light emitted from each branch, as it was reflected from a Spectralon spectrally flat diffuse reflective surface target (Labsphere, Inc., North Sutton, N.H.). The first and second branch separation angle (e.g., angle A in FIG. 2) remained constant throughout the experiment at fourteen degrees.

TABLE 1

| Angle | | | | | Color from | |
|---|---|---|---|---|---|---|
| between first | Flux in | Flux in | Color from | | Second | |
| branch and | First | Second | First Branch | | Branch | |
| stem | Branch | Branch | x | y | x | y |
| 173 degrees | 49% | 51% | .377 | .406 | .376 | .405 |
| 174 degrees | 57% | 43% | | | | |
| 176 degrees | 63% | 37% | .376 | .402 | .377 | .403 |
| 177 degrees | 64% | 36% | | | | |
| 180 degrees | 68% | 32% | .376 | .405 | .378 | .403 |

In Table 1, measurements for a symmetrical Y having branches with equal cross-sectional areas, which, in an unflexed configuration, splits the light emitted evenly between two downstream branches, were recorded. The core of the Y for the experiment was 1.3 cm (0.5″) in diameter and there was no cladding (i.e., the fiber employed an “air” cladding). The branches and stem were each 7.6 cm (3″) long.

To prepare the Y splitter, a two-part brass mold was prepared by machining two identical halves of the mold from a brass block to the dimensions noted for the Y splitter, then polishing the molding surfaces to optical tolerances. The two parts of the mold were clamped together, and a curable polyurethane precursor mixture was poured in and allowed to cure. The curable polyurethane precursor mixture comprised 19.65 g bis(4-isocyanatocyclohexyl)methane (for example, those available under the trade designation Desmodur W, Bayer Corp., Pittsburgh, Pa.), 19.8 g isocyanurate-containing polyisocyanate (for example, Desmodur N-3300, Bayer Corp.), 40 g polyester diol (for example, CAPA 200 polyol, Solvay Interox, Houston, Tex.), 10 g polyester triol (for example, CAPA 301, Solvay Interox). The mixture was stirred at 23° C. under pump vacuum for 30 minutes, after which 0.67 g dibutyltin dimercaptide polymerization catalyst (for example, Foamrez UL-1, Witco Corp., Greenwich, Conn.) was added. Vacuum was reestablished and the mixture was stirred for an additional minute, then allowed to equilibrate for one minute to remove entrained gasses, then vacuum was released. The mixture was poured into the closed two-piece brass mold and allowed to cure at 23° C. for one hour. If necessary, the cured device could be further post-cured by heating at 100° C. for one hour, outside of the mold. Optical properties of the device were then determined.

A Labsphere FIMS-P400, photopically filtered, hand-held 10.2 cm (4″) integrating sphere (Labsphere, Inc., North Sutton, N.H.) was used to measure the flux emitted from each branch, and a Quiet Lightning QL-60Y (Lumenyte International Corp., Costa Mesa, Calif.) light source was used to inject light directly from a harness into the flexible Y splitter. Finally, the flux distribution calculation is based on the total flux exiting the Y, i.e., the sum of the two branches, and not based on the total flux entering the stem.

As the measured data in Table 1 illustrates, at a 173 degree angle, i.e., when the symmetrical Y splitter is in a normal or “unflexed” configuration, the flux is approximately symmetrical with respect to both flux and color of light emitted. When the joint between one of the branches, the “first branch,” and the stem was flexed, increasing the angle of that branch with respect to the upstream stem to a 180-degree angle, i.e., when the first branch was essentially “straight” with respect to the Y stem, the flux in the first branch increased to 68%, while the flux in the second branch decreased to 32%. However, the color from the first branch and the second branch remained uniform (i.e., any difference was not discernible to an observer). It should also be noted that intermediate points between the “unflexed” 173-degree configuration and the “flexed” 180-degree configuration were also measured, illustrating the transition from equal flux to the 68%/32% distribution. At each of the intermediate points, the color integrity between the two branches again remained uniform, i.e., not discernible to an observer (in this experiment, the color remained the same within experimental error).

The method and system described in detail herein was therefore validated, and the method and system for adjusting flux emitted from multiple downstream branches while maintaining color integrity was shown to be satisfactory.

Of course, if a symmetrical uniform splitter with a greater number of branches was used, for example, the splitter as illustrated in FIG. 3, again the input light could be evenly distributed among the downstream branches, provided the splitter was unflexed and the downstream branches symmetrically arranged. If a non-uniform distribution of light was desired for a specific application, a splitter having uniform branches could be used in accordance with the method/system of the present invention. In this case, the angles that each of the downstream branches form with the stem determine the amount of flux emitted from each downstream branch.

It should be noted that while a flux distribution of up to 80% in one branch and 20% in the other is illustrated in FIG. 2a for a “uniform” splitter, a “non-uniform” splitter, i.e., a splitter with multiple branches, in which at least two of the branches have different cross-sectional areas, may provide alternate means of distributing flux between the branches, and may provide an even greater distribution of flux between the branches.

Although various embodiments are specifically illustrated and described herein, it will be appreciated that modifications and variations of the present invention are covered by the above teachings and within the purview of the appended claims without departing from the spirit and intended scope of the invention. For example but without limitation, as previously mentioned, the optical splitter might have any number of downstream branches, located in any plane.

In addition, the present invention is equally applicable to splitters having any cross-sectional shape. For example, it may be advantageous if the cross-sectional shape of the splitter is a truncated circle having a planar surface, a configuration that resembles the letter “D”, a “triangular” shaped surface, or square or rectangular shapes. In addition, the present invention is also applicable to splitters having more than one “input” or stem which receives the input light and which works on the same principle described in detail above.

What is claimed is:

1. A method of controlling an amount of light emitted from each of a plurality of branches of an optical splitter comprising the steps of:
providing an optical splitter including a stem and at least two branches integrally connected to the stem, wherein a junction between the stem and the at least two branches is flexible and wherein the at least two branches each have a uniform cross-sectional area;
maintaining a fixed angle between each of the at least two branches; and
controlling the amount of light emitted from each of the at least two branches by adjusting an angle between the stem of the optical splitter and the at least two branches.

2. The method according to claim 1, wherein the stem and the at least two branches of the optical splitter include light guides.

3. The method according to claim 2, wherein the light guides include light fibers.

4. The method according to claim 1, wherein the color of the light emitted from each of the at least two branches is substantially the same as the color of light input at the stem.

5. The method according to claim 1, wherein at least two of the at least two branches are unequal in cross-sectional area.

6. The method according to claim 1, wherein at least two of the at least two branches are equal in cross-sectional area.

7. The method according to claim 1, wherein the optical splitter includes a Y-shape, having a stem and two branches.

8. The method according to claim 7, wherein an angle of one of the two branches with the stem of the optical splitter is between approximately 90 and 180 degrees.

9. The method according to claim 7, wherein the two branches are symmetrical and form a fixed angle between approximately 1 and 90 degrees.

10. The method according to claim 9, wherein the fixed angle lies between approximately 1 and 20 degrees.

11. The method according to claim 7, wherein an angle of one of the two branches with the stem of the optical splitter lies between approximately 150 and 180 degrees.

12. The method according to claim 1, wherein the optical splitter includes a substantially optically transparent material.

13. The method according to claim 1, wherein the optical splitter comprises a material selected from the group consisting of urethane, silicon and acrylate materials.

14. The method according to claim 1, wherein the optical splitter comprises a urethane.

15. The method according to claim 1, wherein the optical splitter includes a low-index cladding.

16. The method according to claim 15, wherein the low-index cladding includes a flouropolymer.

17. The method according to claim 1, wherein the optical splitter is spliced between one source fiber and a plurality of receiving fibers equal in number to the plurality of branches of the optical splitter.

18. The method according to claim 1, wherein the stem and the at least two branches of the optical splitter comprise an integrally formed single light guide device.

19. The method according to claim 1, wherein the adjusted angles between the stem and the at least two branches of the splitter are such that an alignment of the plurality of branches with the stem of said optical splitter is asymmetric, and further wherein different amounts of light are emitted from at least two of the plurality of branches.

20. A system for controlling the amount of light emitted from a plurality of downstream branches, the system comprising:
an optical splitter mounted on a splitter adjustment device, said splitter having an upstream stem and at least two downstream branches, wherein each of the upstream stem and downstream branches are formed from light guides, wherein the at least two downstream branches each have a uniform cross-sectional area, wherein a junction between the upstream stem and the at least two downstream branches is flexible, and further wherein there is maintained a fixed angle between each of the at least two branches and wherein an amount of light emitted from each of the at least two downstream branches of said optical splitter is adjusted by using the splitter adjustment device to adjust the angle between the upstream stem and the at least two downstream branches of the optical splitter.
